(19) United States
(12) Patent Application Publication
(10) Pub. No.: US 2023/0104986 A1
(43) Pub. Date: Apr. 6, 2023

(54) PORTABLE INSECT CONTROL SYSTEM

(71) Applicant: E. MISHAN & SONS, INC., New York, NY (US)

(72) Inventor: Robert M. Perlman, New York, NY (US)

(73) Assignee: E. MISHAN & SONS, INC., New York, NY (US)

(21) Appl. No.: 17/484,033

(22) Filed: Sep. 24, 2021

(51) Int. Cl. A01M 5/02; A01M 1/04; A01M 1/22; A01M 1/20

(52) U.S. Cl. CPC A01M 5/02; A01M 1/04; A01M 1/223; A01M 1/2094

(57) ABSTRACT

A portable insect control trap has, in a single portable device, two modes of attracting insects, including a first mode adapted to attract flying insects (e.g. insect-attracting light) and a second mode adapted to attract crawling insects (e.g., bait). The same device has two modes of killing insects, including a first mode adapted to kill flying insects (e.g. an electrified grid) and a second mode adapted to kill crawling insects (e.g. an electric heating element). The first mode of attracting is associated with the first mode of killing, the second mode of attracting is associated with the second mode of killing.

### STATEMENT REGARDING PRIOR DISCLOSURES BY THE INVENTORS OR JOINT INVENTORS UNDER 37 C.F.R. 1.77(B)(6)

Devices were offered for sale by the applicant/assignee E. Mishan & Sons, Inc. less than one year before the priority date of the present application, under the name BELL+HOWELL® DOUBLE ZAPPER™. The applicant/assignee obtained the BELL+HOWELL® DOUBLE ZAPPER™ technology directly or indirectly from the named inventor of the present application. Said BELL+HOWELL® DOUBLE ZAPPER™ devices are “inventor-originated disclosures” within the exceptions defined in 35 U.S.C. 102(b)(1).

### FIELD AND BACKGROUND OF THE INVENTION

The subject technology relates to portable insect control traps.

### SUMMARY OF THE INVENTION

According to an aspect of the subject technology, a portable insect control trap has, in a single portable device, multiple modes of attracting insects, including a first mode adapted to attract flying insects (mosquitos, flies, moths, and similar small flying insects) and a second mode adapted to attract crawling insects (roaches, ants, ticks, and similar small crawling insects). The same device has multiple modes of killing insects, including a first mode adapted to kill flying insects and a second mode adapted to kill crawling insects. The first mode of attracting is associated with the first mode of killing, the second mode of attracting is associated with the second mode of killing.

In an embodiment, the first mode of attracting is an electric light source which, when activated, emits light, including wavelengths of light which attract insects, such as certain colors of visible light, “black light” and/or UV-A light. The second mode of attracting is the provision of attractive lures, baits and/or chemical attractants (hereinafter “bait”) disposed within the device.

In an embodiment, the first mode of killing is a high-volage electric grid which electrocutes and thereby kills flying insects encountering the grid in pursuit of the first mode of attracting. The second mode of killing is an electric heating element disposed in a chamber of the device, which heats and thereby kills crawling insects entering the chamber in pursuit of the second mode of attracting.

The electrical systems of the device (i.e., the electric grid, light source, and electric heating elements) are powered by a rechargeable battery and are driven by control circuitry which controls the operation of the system as further described herein.

In an embodiment, a portable insect control device comprises a first mode of attracting insects associated with a first mode of killing insects, and a second mode of attracting insects associated with a second mode of killing insects, wherein the first mode of attracting insects is different from the second mode of attracting insects and the second mode of killing insects is different from the second mode of killing insects; the first mode of attracting insects is emission of insect-attracting light and the first mode of killing insects is electrocution; and the second mode of attracting insects is the provision of insect-attracting bait and the second mode of killing insects is heating.

In an embodiment, a portable insect control device comprises a housing; wiring, device electronics, and a rechargeable battery within the housing; a light source configured to emit insect-attracting light, the light source associated with a grid of exposed wires, the light source and grid disposed on the housing and operatively and electrically connected to the wiring, device electronics, and rechargeable battery to attract and electrocute insects; and a bait trap configured to hold insect-attracting bait, the bait trap associated with a heating element, the bait trap and heating element disposed within the housing, the heating element operatively and electrically connected to the wiring, device electronics, and rechargeable battery to attract and destroy insects with heat.

The various features of novelty which characterize the subject technology are pointed out with particularity in the claims annexed to and forming a part of this disclosure. For a better understanding of the subject technology, its operating advantages and specific objects attained by its uses, reference is made to the accompanying drawings and descriptive matter in which preferred embodiments of the subject technology are illustrated.

### BRIEF DESCRIPTION OF THE DRAWINGS

FIG. 1 is an elevation view of a device according to a non-limiting embodiment of the subject technology.

FIG. 2 is a perspective view of the device of FIG. 1 with the shroud removed to show the illuminated high-voltage trap.

FIG. 3 is a perspective view of the device of FIG. 1 with the shroud, grid, and grid support removed to show the light source.

FIG. 4 is an elevation view of a grid and a grid support for a device according to a non-limiting embodiment of the subject technology.

FIG. 5 is a top view of the grid and grid support of FIG. 4.

FIG. 6 is a perspective view of a housing base for a device according to a non-limiting embodiment of the subject technology.

FIG. 7 is a perspective view of a drawer for a device according to a non-limiting embodiment of the subject technology.

FIG. 8 is a perspective view of the drawer of FIG. 7 with the roof removed to show the central compartment of the drawer.

FIG. 9 is a perspective view of the device of FIG. 1 with upper components removed to show elements housed within the housing.

FIGS. 10-13 are electrical schematics showing features of an embodiment of the subject technology.

FIG. 14 is a parts list for the schematics of FIGS. 10-13.

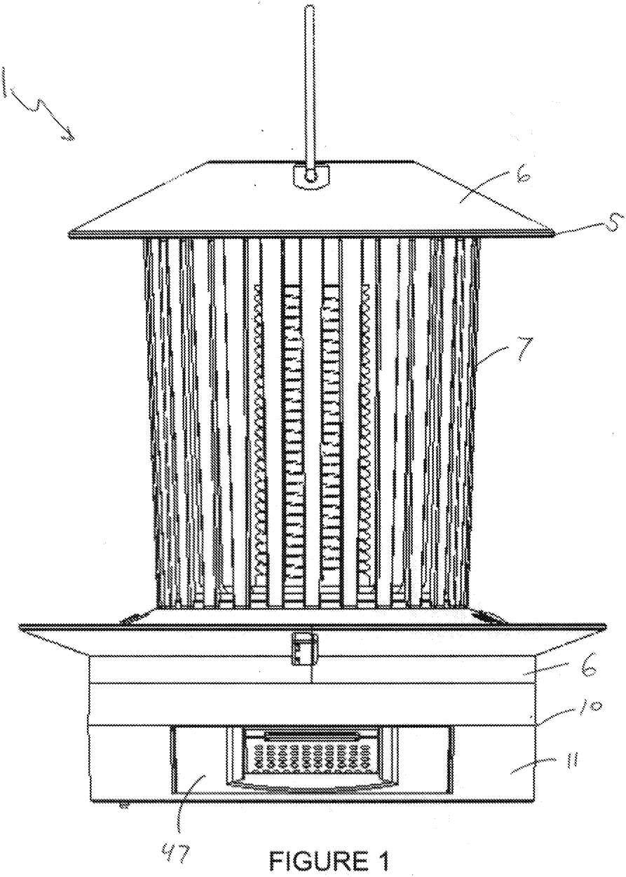

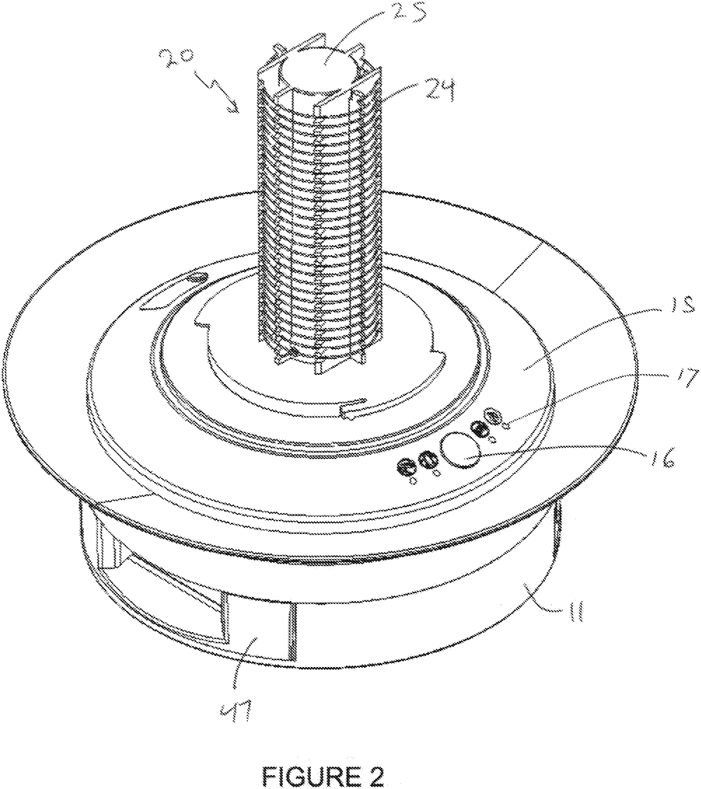

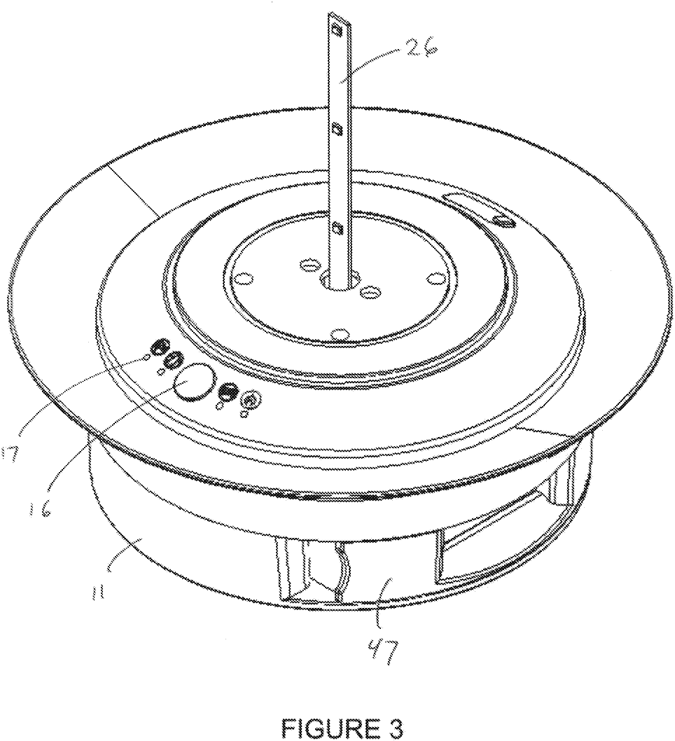

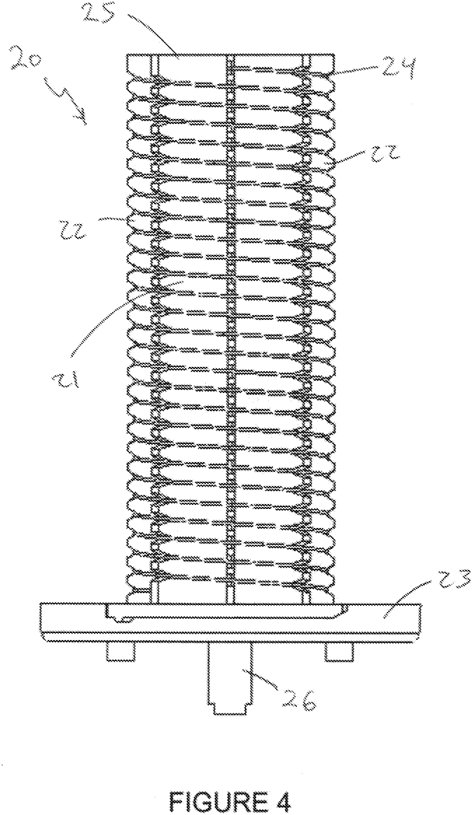

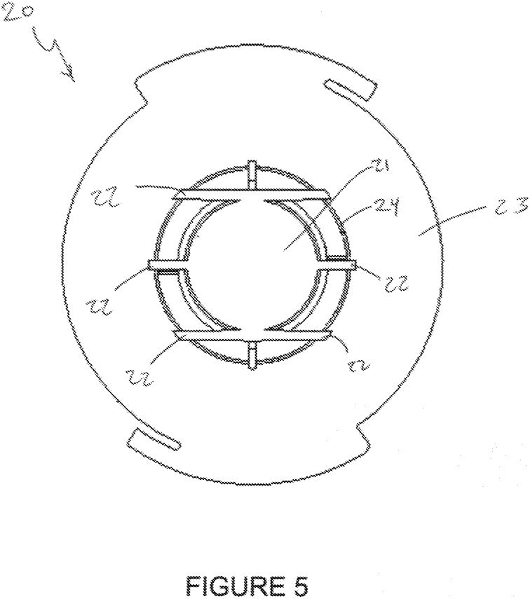

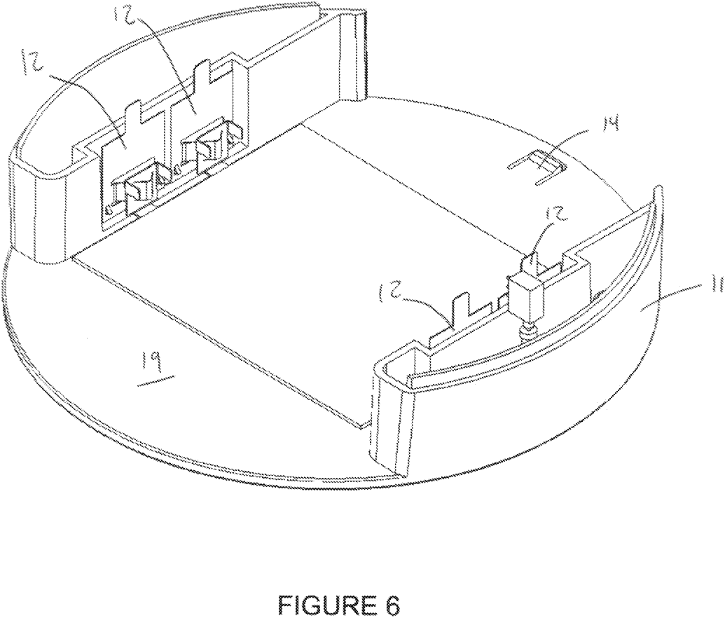

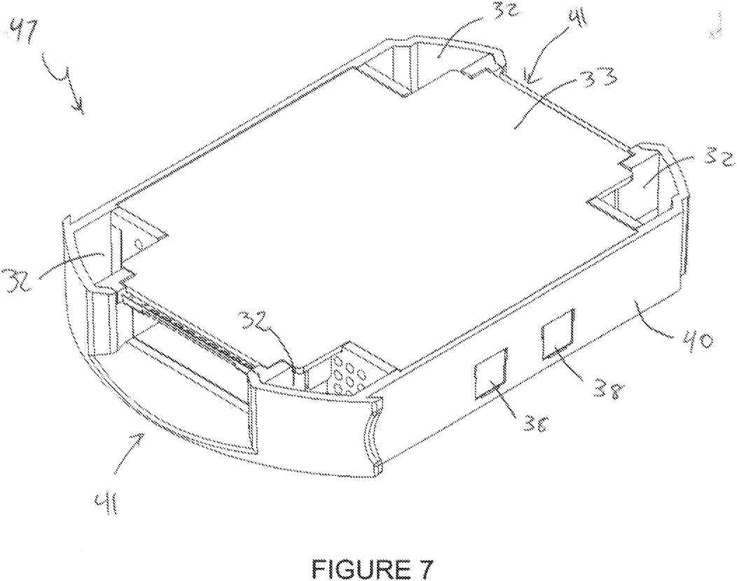

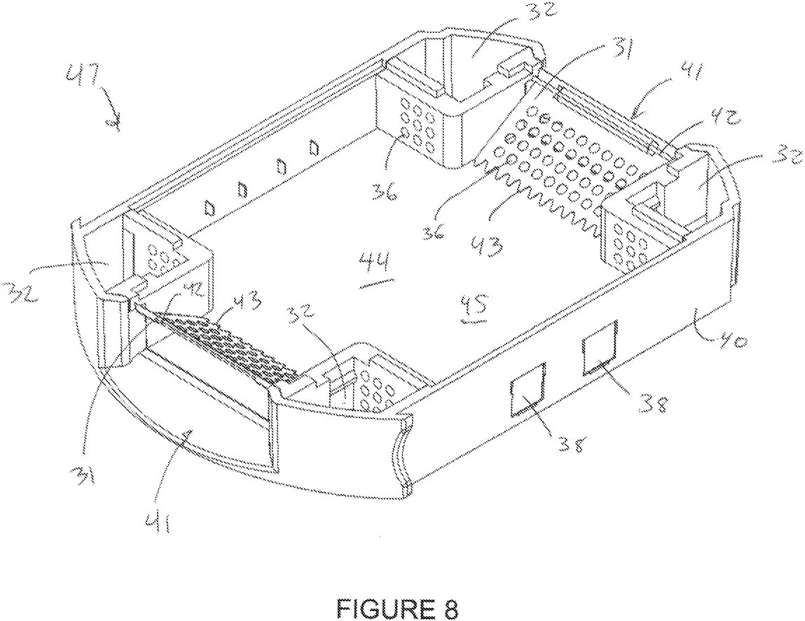

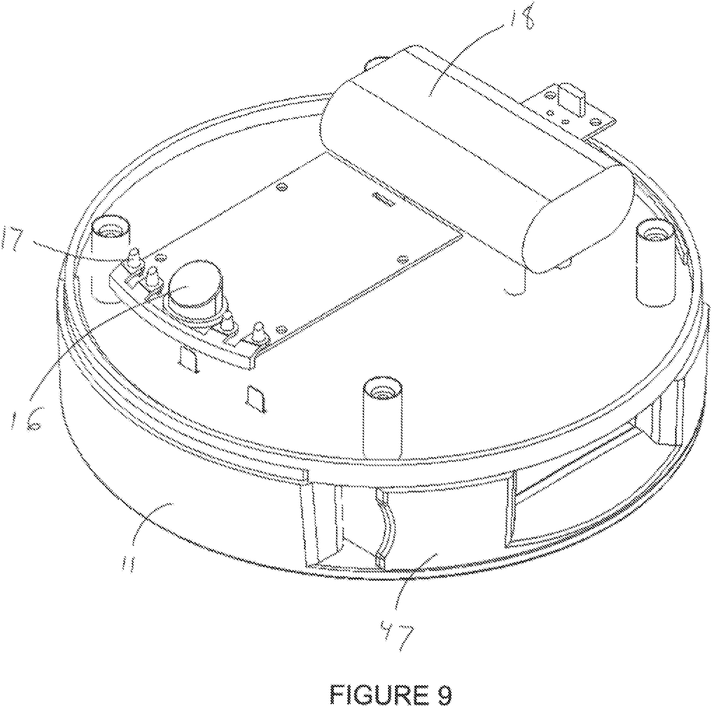

### DETAILED DESCRIPTION OF THE INVENTION

According to a non-limiting embodiment of the subject technology, as shown in Figures, device 1, which in an embodiment is a portable insect control trap, comprises a housing 10 for housing electrical and mechanical components of device 1, illuminated high-voltage trap 20 disposed on housing 10 for attracting and electrocuting flying insects, and baited high-temperature trap 30 disposed in housing 10 for attracting and killing crawling insects.

In a non-limiting embodiment, housing 10 has the following structure. Housing 10 comprises base 11 and cover 15, the assembly of base 11 and cover 15 defining a hollow internal compartment for housing wiring and device electronics 27 (which may be disposed on a printed circuit board housing in housing 10), rechargeable battery 18, and mechanical components of device 1. Button 16 is disposed on a surface of housing 10, for example on cover 15, and is electrically and operatively connected to the wiring and device electronics for user control of device 1 as will be hereinafter described. LEDs 17 are disposed on a surface of housing 10, for example on cover 15, and are electrically and operatively connected to the wiring and device electronics to display the operational status of the device as will be hereinafter described. Housing 10 comprises an external port for admitting an electrical connection, such as a USB port, for recharging a rechargeable battery 18 housed in housing 10 as is known in the art. Housing 10 comprises bay 19 for accommodating the baited high-temperature trap 30 as will be hereafter described. The floor of bay 19 may include a retention tab 14 for retention of the drawer 47 of baited high-temperature trap 30. Side walls of bay 19 have disposed thereon electrical contacts 12 electrically and operatively connected to the wiring and device electronics for operation of the baited high-temperature trap 30 as will be hereinafter described.

Illuminated high-voltage trap 20 is disposed on housing 10 and is electrically and operatively connected to the wiring and device electronics housed in housing 10. In a non-limiting embodiment, the illuminated high-voltage trap 20 has the following structure. A grid 24 made of at least two non-insulated metal wires, i.e., a hot wire and a cold wire, is disposed on and supported by grid support 25, which in turn is disposed on and supported by housing 10. Grid 24 is supported on grid support 25 so that the hot wire and cold wire are not contacting each other. Grid support 25 comprises tube 21, ribs 22 on tube 21, and base 23. At least tube 21 is made of a transparent or translucent material such as glass or transparent plastic material. Grid support 25 may be entirely made in one piece of such transparent or translucent material. A light source 26, which may be light-emitting diodes disposed on two sides of a flat printed circuit board, is disposed within tube 21 and is selected, driven and configured to emit light which is attractive of flying insects, for example, UV light. The light source 26 is electrically and operatively connected to the wiring and device electronics housed in housing 10. When illuminated, high-voltage trap 20 is activated by the wiring and device electronics, the light source 26 is powered and driven to emit insect-attracting light. The wiring and device electronics applies a high DC or AC voltage to the hot wire of grid 24, which may be generated by, for example, a DC voltage multiplier circuit as is known in the art. The high-voltage applied to grid 24 may be 1 kV, 1.5 kV, 2 kV, 2.5 kV, or within the range of 1 kV-2.5 kV, above the voltage of the cold wire of grid 24. The light emitted by the light source attracts flying insects, which encounter the grid 24 and are electrocuted.

In an embodiment, illuminated high-voltage trap 20 is surrounded by a shroud 5. In an embodiment, shroud 5 has the following structure. Lid 6 is attached to the top of cage 7. Cage 7 is comprised of slats disposed around shroud 5, with sufficient space between the slats to admit flying insects seeking the light source 26. Shroud 5 is removably attached to housing 10, cover 15, or grid support base 23, by for example a sliding tab-in-slot structure.

Baited high-temperature trap 30 comprises drawer 47 and associated electronic circuitry. Drawer 47 is housed in bay 19 in housing 10 and is slidably removable from and insertable into bay 19. In an embodiment, drawer 47 has the following structure. Drawer 47 comprises drawer body 40. Drawer body 40 has formed therein central compartment 44. Roof 33 is removably attached to drawer 47 by, for example, tabs engaging slots formed in drawer 47. Roof 33 may be made of a transparent material such as glass or transparent plastic. Central compartment 44 is lined with a liner 45 made of an electrically-conductive and heat-conductive material, for example, sheet metal. Drawer body 40 has formed therein one or more bait compartments 32 (only one is numbered), which are open at the top for insertion and removal of bait (not shown). Drawer body 40 is formed with one or more entries 41 for admission of insects seeking the bait material. Entries 41 are gated by hinged gates 31. Hinged gates 31 are suspended from hinge rods 42 disposed across upper portions of entries 41 and have lower edges 43. Hinged gates 31 may be made of a thin sheet of metal or plastic or other suitable material and have a closed position. In the closed position, lower edges 43 of hinged gates 31 the floor of drawer 47 or liner 45 and support hinged gates 31 at an angle with respect thereto. Hinged gates 31 are not biased to the closed position by a spring or other means, rather their own weight tends to pivot them about hinge rods 42 into the closed position. Hinged gates 31 and walls of bait compartments 32 have throughgoing holes 36 to better enable insects to detect the bait in bait compartments 32. Thus, incoming insects seeking the bait material can push the hinged gates 31 open, but once entering the central compartment 44, hinged gates 31 will revert to the closed position. Due to the angled attitude of hinged gates 31 in the closed position, trapped insects will be unable to push them open from the inside. Drawer 47 has electrical contacts 38 disposed on opposite sides thereof, which are electrically connected to a drawer heating element. In an embodiment, drawer heating element is liner 45. In another embodiment, a separate heating element is disposed beneath liner 45 and is electrically connected to contacts 38. When drawer 47 is in its place in bay 19, electrical contacts 38 are in electrically conducting contact with contacts 12, and thus the heating element is electrically connected to the power and wiring and device electronics. In use, the user removes drawer 47 from bay 19, inserts bait material into one or more of compartments 32, and replaces drawer 47 in bay 19, which electrically connects the heating element to the wiring and device electronics via contact of contacts 12 and 38. When activated for heating, the wiring and device electronics pass electrical current through the heating element (for example liner 15) sufficient to raise the temperature of liner 15 to destroy any insects trapped in central compartment 44. Drawer 47 can be removed and roof 33 removed from drawer 47 to enable removal of any dead insects.

The wiring and device electronics are configured to operate the device 1, in a non-limiting embodiment, as follows. Device 1 has the following modes: off, high-voltage trap on, heat trap on, heating in progress. From the off mode in which all functions are not powered, a first press of button 16 will turn the device on in “high-voltage trap on” mode in which the grid 24 and light source 26 are powered on. A second press of button 16 will change the mode to “heat trap on” mode and turn off the high-voltage trap. A third press of button 16 will change the mode to “high-voltage trap on” and “heat trap on” modes simultaneously, and both the high-voltage and heat traps will be powered on. A fourth press of button 16 will change the mode to “high-voltage trap on” and “heat trap on” and “heating in progress” modes simultaneously. When the “heat trap on” mode is in effect, the wiring and device electronics will go into “heating in progress” mode and drive the high-temperature trap to heat up, at a predetermined interval for a predetermined period of time (in an embodiment, the predetermined interval is three hours and the period of time is eight minutes). Alternatively, the “heating in progress” mode may be activated when the intrusion of insects into the trap is detected by, for example, weight sensors, strain sensors, an infrared emitter-receiver sensor system, or other detectors disposed in the bait trap and connected to the device electronics. When the “heating in progress” mode is manually selected by a fourth press of the button as described, or by detection of insects by sensors, a heating cycle will begin for the predetermined period of time without regard for the predetermined interval. A fifth press of button 16, or a long three-second press, will change the mode to “off.” LEDs 17 are driven by the wiring and device electronics to display the current mode(s). Additionally, if the wiring and device electronics detect that battery 18 has a low charge, an LED will be driven to flash on and off to alert the user that charging is required. When charging is in progress (i.e. the device is connected to a power supply via the external port), a different LED will flash during charging until the battery 18 is fully charged. Additionally, a button switch may be provided at the bottom of base 23 which will detect when the device 1 is knocked over or otherwise not in contact with the surface below, upon which detection the device electronics will change the mode to “off.”

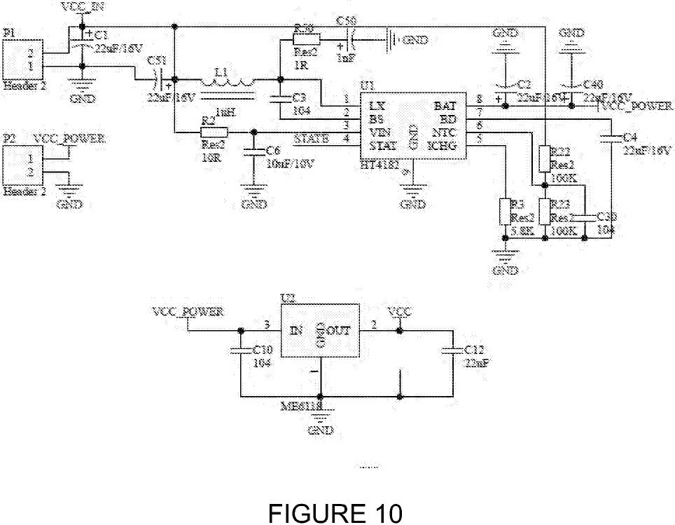

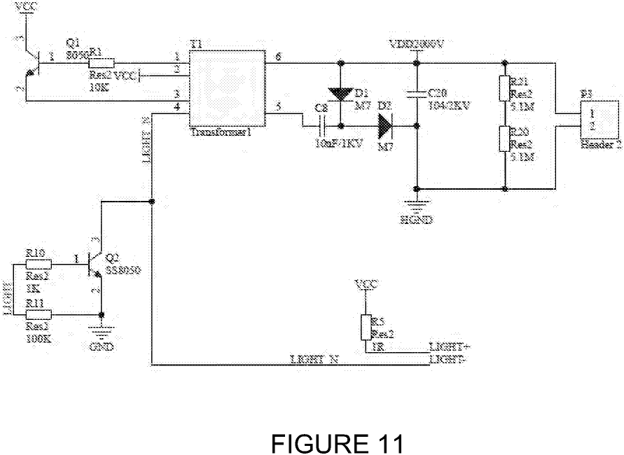

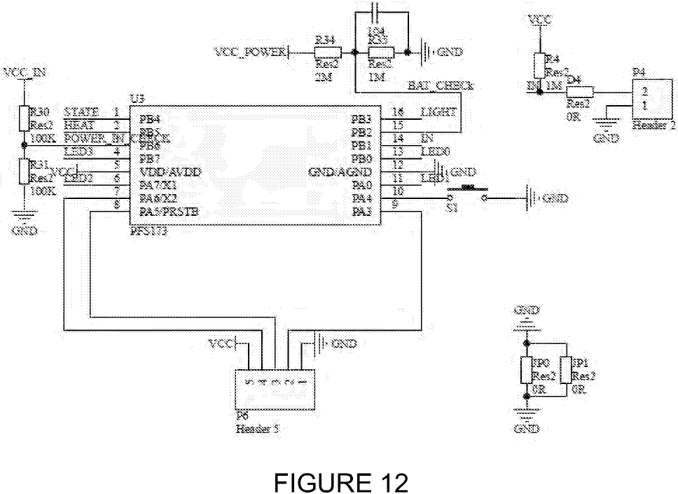

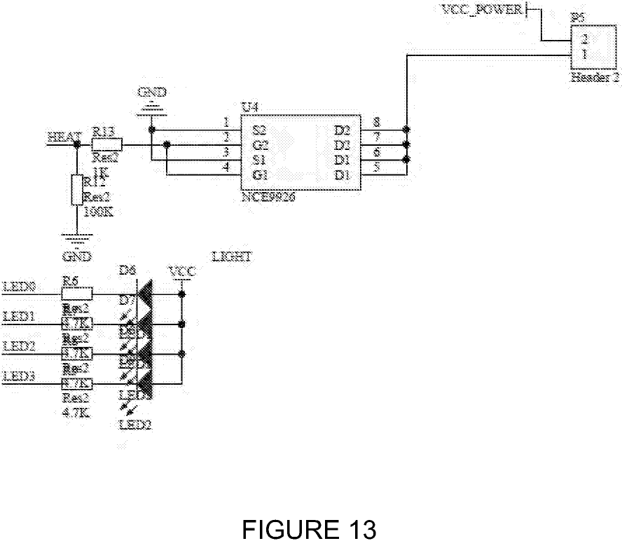

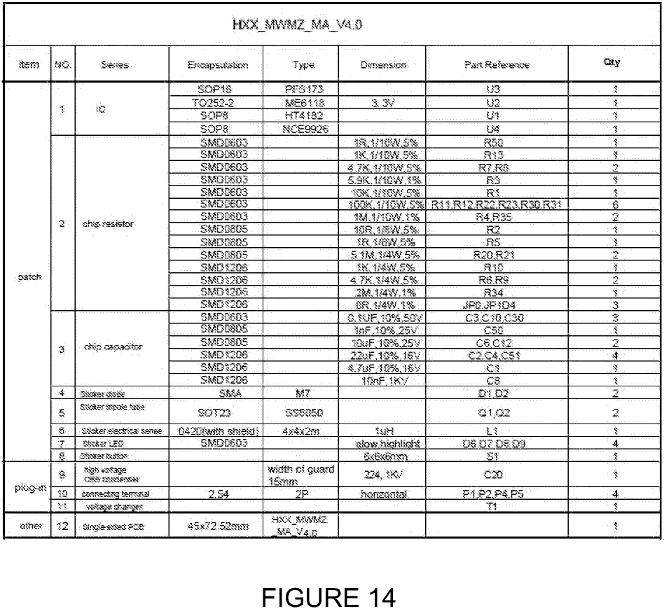

FIGS. 10-13 are electrical schematics showing the configuration of wiring and device electronics in an embodiment of the subject technology, with reference to the parts list of FIG. 14.

While specific embodiments of the invention have been shown and described in detail to illustrate the application of the principles of the invention, it will be understood that the invention may be embodied otherwise without departing from such principles. It will also be understood that the present invention includes any combination of the features and elements disclosed herein and any combination of equivalent features. The exemplary embodiments shown herein are presented for the purposes of illustration only and are not meant to limit the scope of the invention.

What is claimed is:

1. A portable insect control device comprising a first mode of attracting insects associated with a first mode of killing insects, and a second mode of attracting insects associated with a second mode of killing insects, wherein the first mode of attracting insects is different from the second mode of attracting insects and the second mode of killing insects is different from the second mode of killing insects.

2. The portable insect control device of claim 1 wherein the first mode of attracting insects is emission of insect-attracting light and the first mode of killing insects is electrocution.

3. The portable insect control device of claim 1 wherein the second mode of attracting insects is the provision of insect-attracting bait and the second mode of killing insects is heating.

4. A portable insect control device comprising:
a housing;
wiring, device electronics, and a rechargeable battery within the housing;
a light source configured to emit insect-attracting light, the light source associated with a grid of exposed wires, the light source and grid disposed on the housing and operatively and electrically connected to the wiring, device electronics, and rechargeable battery to attract and electrocute insects; and
a bait trap configured to hold insect-attracting bait, the bait trap associated with a heating element, the bait trap and heating element disposed within the housing, the heating element operatively and electrically connected to the wiring, device electronics, and rechargeable battery to attract and destroy insects with heat.

5. The portable insect control device of claim 4 further comprising a grid support tube disposed on the housing, the grid support tube being translucent or transparent, the light source disposed within the tube, the grid of exposed wires wound around the grid support tube and supported by ribs extending from the grid support tube.

6. The portable insect control device of claim 4 wherein the bait trap and heating element are disposed within a drawer removable from a bay of the housing.

7. The portable insect control device of claim 6 wherein the drawer has a first set of electrically conductive contacts on a side thereof, disposed to contact a second set of electrically conductive contacts on a side of the bay.

8. The portable insect control device of claim 6 wherein the drawer comprises an entryway gated by a gate, the gate hingedly connected to an upper portion of the entryway, the gate contacting a floor of the drawer in a closed position such that the gate is angled inward within the entryway to permit insects to crawl under the gate when entering the bait trap but to exclude insects from crawling under the gate to exit the bait trap.
